(19) United States
(12) Patent Application Publication
(10) Pub. No.: US 2005/0130533 A1
(43) Pub. Date: Jun. 16, 2005

(54) Woven product exhibiting durable arc flash protection and the articles thereof

(76) Inventor: Francois Lapierre, Bossard (CA)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/942,650

(22) Filed: Sep. 16, 2004

Related U.S. Application Data
(60) Provisional application No. 60/503,203, filed on Sep. 16, 2003.
(60) Provisional application No. 60/503,254, filed on Sep. 16, 2003.

(51) Int. Cl. D03D 15/00; B27N 9/00

(52) U.S. Cl. 442/197; 442/301; 442/189; 428/920; 428/921

(57) ABSTRACT

The present invention relates generally to a woven product exhibiting arc protection, and specifically to a woven product which exhibits an arc thermal protective value of at least 8.0 throughout the period of at least 125 cumulataive wash and wear cycles. The woven product comprises an aramid fibrous component and a flame retardant rayon or malamine fibrous component. The fibrous components are preferentially blended in the ratio of at least 50% aramid to the remainder flame retardant rayon or malamine.

### TECHNICAL FIELD

The present invention relates generally to a woven product exhibiting arc protection, and specifically to a woven product which exhibits an arc thermal protective value of at least 8.0 throughout the period of at least 125 cumulative wash and wear cycles.

### BACKGROUND OF THE INVENTION

In the United States per annum approximately sixty electrical workers are killed in construction by electric current and significantly many more are injured. Over half of the deaths are from working on energized (“live”) electric circuits without proper protection. At least one-third of the electrocutions occur at low voltage, under 600 volts. Many of the initial injuries are inflicted as a result of discharge of electricity through inadvertent or incidental grounding of the live circuit, known as “arc flash”.

To protect electrical workers from arc flash there are a number of fabric garments which act to impart enhanced thermal protection, such products referred to as Personal Protection Equipment, or “PPE”. The assessment of which PPE's, or combinations or layers of PPE, to use are directly related to the level of flash protection boundary required for establishing a temporary and safe work environment. The flash protection boundary is determined by the distance at which PPE is needed to prevent incurable burns (2nd degree or worse) if an arc flash does inadvertently occur. For systems of 600 volts and less, the flash protection boundary is 4 feet, based on an available bolted fault current of 50 kA (kiloamps) and a clearing time of 6 cycles (0.1 seconds) for the associated circuit breaker to act, or any combination of fault currents and clearing times not exceeding 300 kA cycles. Such information being made routinely available through the National Fire Protection Agency code 70E.

Heretofore, fabric garments used in the role of PPE for arc flash protection have heavily relied upon the use of cotton fiber yarns. U.S. Pat. No. 5,223,334, to Green, suggest optimum performance in an arc flash garment wherein a majority of flame retardant cotton is used in the construction of the base fabric. Such cotton fiber constructs have been found to have a very limited usable lifespan in PPE applications due to degradation of the cotton component when subjected to abrasive wear and repeated launderings.

An unmet need exists for a material usable in the construction of articles having an arc thermal protective value of at least 8.0 for no less than 125 cumulative wash and wear cycles, which are light weight in nature, and which do not comprise melt-susceptible thermoplastic components.

### SUMMARY OF THE INVENTION

The present invention relates generally to a woven product exhibiting arc protection, and specifically to a woven product which exhibits an arc thermal protective value of at least 8.0 throughout the period of at least 125 cumulative wash and wear cycles. The woven product comprises an aramid fibrous component and a flame retardant rayon fibrous component. The fibrous components are preferentially blended in the ratio of at least 50% aramid to the remainder flame retardant rayon.

The woven product of the present invention comprises an aramid fibrous component and a flame retardant melamine fibrous component, whereby the fibrous blend has a favorable hand, as well as drapeability that lends to the comfort of a garment. The fibrous components are preferentially blended in the ratio of at least 50% aramid to the remainder flame retardant melamine.

It is within the purview of this present invention that the woven material can produced by either weaving or knitting means using yarns produced by such suitable means including, but not limited to, ring spinning and air-jet spinning.

It is further within the purview of this present invention that various articles can be produced from the arc flash protective material, including such exemplary pieces as shirts, pants, gloves, balaclavas, undergarments, aprons, and blankets.

### DETAILED DESCRIPTION

While the present invention is susceptible of embodiment in various forms, there is shown in the figures, and will hereinafter be described a presently preferred embodiment of the invention, with the understanding that the present disclosure is to be considered as an exemplification of the invention, and is not intended to limit the invention to the specific embodiment illustrated.

To fabricate a woven product exhibiting arc protection, yarns are first produced wherein the yarns comprise an aramid and a flame retardant component. The aramid is present in the yarns in the range of at least 50% by weight, preferably in the range of at least 60% by weight, and most preferably in the range of at least 65% by weight. Suitable aramid fibers include the use of either para-aramids (i.e. Nomex RTM fibers of Dupont) or meta-aramids (i.e. Kevlar RTM fibers of Dupont), or the combinations thereof. The remainder of the fibrous component weight is selected from flame retardant rayon fibers (i.e. as commercially available by Lenzing).

To fabricate a woven product exhibiting arc protection, yarns are first produced wherein the yarns comprise an aramid and a flame retardant component. The aramid is present in the yarns in the range of at least 50% by weight, preferably in the range of at least 60% by weight, and most preferably in the range of at least 65% by weight. Suitable aramid fibers include the use of either para-aramids (i.e. Nomex RTM fibers of Dupont) or meta-aramids (i.e. Kevlar RTM fibers of Dupont), or the combinations thereof. The remainder of the fibrous component weight is selected from flame retardant melamine fibers, such as Basofil® fibers (i.e. as commercially available by BASF).

The yarns employed in the present invention utilize most typically a fibrous component in the form of finite length staple fibers, though continuous filaments could be used in part or whole, which are combined by suitable spinning means including, but not limited to, ring spinning and air-jet spinning. The staple fibers used herein have a linear density suitable for wearing apparel, wherein said density is less than 9 denier, preferably less than 4 denier, and most preferably less than 2.5 denier. The staple fiber lengths can be in the range of about 0.5 to 3.5 inches, with the range of 1.0 to 2.0 inches being preferred. The cross-sectional profile and the existence or nature of crimp is not a limitation to the practice of the present invention.

The yarns comprising an aramid and a flame retardant rayon component may be combined into a woven product exhibiting arc protection by either weaving or knitting means as exemplified in “Introductory Textile Science” by M. L. Joseph, CBS College Publishing, 1986, incorporated herein by reference.

Upon formation of the woven product exhibiting arc protection, the product is optionally subjected to further aesthetic and performance modifying chemistries. Aesthetic modifying chemistries can include use of dyes and pigments which can be selected to alter the coloration of any one fibrous components or the entirety of the yarn composition. Performance modifying chemistries include those directed to modifying the performance of the product by topical application or integration. Hydrophobic modification includes the incorporation of hydrophobic agents such as fluorocarbons taught in U.S. Pat. No. 5,178,931, hereby incorporated by reference. Suitable hydrophilic agents include the oleyl ethers included in U.S. Pat. No. 6,239,047 and the use of stearic acids in U.S. Pat. No. 5,969,026, both of which are hereby incorporated by reference. Representative chemistries with anti-microbial activity include the use of quaternary ammonium salts, as is well covered by the combination of U.S. Pat. No. 5,300,167, No. 5,569,732, and No. 5,854,147, herein incorporated by reference. U.S. Pat. No. 5,645,627, herein incorporated by reference, teaches static charge retention by use of perfluoroalcohols. U.S. Pat. No. 5,814,688, herein incorporated by reference, teaches suitable static charge dissipation based chemistries.

The woven product exhibiting arc protection may also be subjected to post fabrication mechanical alteration such as by compaction, tentering, calendering, and drying/setting.

### EXAMPLE 1

A woven material made in accordance with the present invention wherein:
A blend of 65% Meta-Aramid (Nomex)/35% F. R. Cellulosic ( F. R. Lenzing) was used.
The material was woven in 3×1 Twill or what is also known as a coarse twill.
Weight of the fabric was 8.0 o.s.y.
Solution dyed Meta-Aramid Fiber (Solution dye Nomex)
Natural Lenzing F. R. dyes so as to obtain a cross-dye effect Chambray).
Performance modifying chemicals were added to achieve the best permanent absorption and wicking characteristics.
The resulting fabric was passed through a tenter frame where chemicals were applied to achieve good permanent press, pilling and laundering shrinkage characteristic.

### EXAMPLE 2

A woven material made in accordance with the present invention wherein:
A blend of 65% Meta-Aramid (Nomex)/35% F. R. Cellulosic ( F. R. Lenzing) was used.
The material was woven in 3×1 Twill or what is also known as a coarse twill.
Weight of the fabric was 8.0 o.s.y.
Solution dyed Meta-Aramid Fiber (Solution dye Nomex)
Lenzing F. R. fiber dyed to achieve a solid shade color.
Performance modifying chemicals were added to achieve the best permanent absorption and wicking characteristics.
The resulting fabric was passed through a tenter frame where chemicals were applied to achieve good permanent press, pilling and laundering shrinkage characteristic.

The Example 2 material was evaluated and found to have the performance attributes on par with conventional cotton arc flash protection products: absorption, wicking, and pilling is stated in Table 1.

The Example material was also found to have laundering durability exceeding conventional cotton arc flash protection products in excess of 125 wash and wear cycles, also denoted in Table 1.

The woven product exhibiting arc protection can be cut and combined to form any of various articles, including such exemplary pieces as shirts, pants, gloves, balaclavas, undergarments, aprons, and blankets.

From the foregoing, numerous modifications and variations can be effected without departing from the true spirit and scope of the novel concept of the present invention. It is to be understood that no limitation with respect to the specific embodiment illustrated herein is intended or should be inferred. The disclosure is intended to cover, by the appended claims, all such modifications as fall within the scope of the claims.

TABLE 1

| | No. of Washings | Example 2 |
|---|---|---|
| Nominal Weight & Weave | | 8.0 opsy - 3 × 1 twill |
| Fabric Color | | Medium Blue |
| Basic Fabric Properties | | |
| Basis Weight (opsy) | 0X | 8.2 |
| | 25X | 9.8 |
| | 100X | 9.8 |
| Thickness(mil) | 0X | 23 |
| | 25X | 34 |
| | 100X | 35 |
| Fabric Comfort Properties | | |
| Air Permeability (cfm/ft²) | 0X | 25.2 |
| | 25X | 22.9 |
| | 100X | 22.5 |
| Vertical Wicking (Total | 0X @ 15 min. | 0.8/0.6 |
| inches @ time) W/F | 25X @ 10 min. | 5.0/5.0 |
| | 100X @ 10 min. | |
| Drop Absorption (sec) Drop/Reflect | 0X | <20 secs |
| Static Decay (70′ F./20% RH) | 0X | |
| Charge Pick-up (volts) | | |
| Warp (Pos/Neg) | | 4150/4000 |
| Fill (Pos/Neg) | | 4233/4000 |
| Decay Time (sec) | | |
| Warp (Pos/Neg) | | 0.01/0.01 |
| Fill (Pos/Neg) | | 0.04/0.01 |
| Thermal Fabric Properties | | |
| Vertical Flammability | | |
| Char Length (in) W/F | 0X | 1.70/1.46 |
| | 25X | 1.48/1.34 |
| | 100X | 1.40/1.34 |
| Afterflame Time (sec) W/F | 0X | 0.0/0.0 |
| | 25X | 0.0/0.0 |
| | 100X | 0.0/0.0 |
| Afterglow Time (sec) W/F | 0X | 0.6/0.5 |
| | 25X | 1.0/0.7 |
| | 100X | 0.7/0.8 |
| TPP Test (spaced) | | |
| TPP Value (cal/cm²) | 0X | 16.9 |
| | 25X | 20.3 |
| | 100X | 17.9 |
| FFF (cal/cm²)/(oz/yd²) | 0X | 2.1 |
| | 25X | 2.1 |
| | 100X | 1.8 |
| Time to Pain (sec) | 0X | 5.7 |
| | 25X | 7.2 |
| | 100X | 6.3 |
| Thermal Shrinkage | 0X | 2.5/0.5 |
| (500° F./5 min.) (%) W/F | | |
| TPP Flame | 0X | 2.8/1.8 |
| Shrinkage @ 5.0 sec. (%) W/F | | |
| Strength & Durability | | |
| Fabric Properties | | |
| Tensile Strength | | |
| Break Strength (lbf) W/F | 0X | 170/116 |
| | 25X | 186/170 |
| | 100X | 181/156 |
| Eb (%) W/F | 0X | 18.4/18.2 |
| | 25X | 41.6/35.1 |
| | 100X | 44.4/35.5 |
| Trap Tear (lbf) W/F | 0X | 26.5/19.9 |
| | 25X | 26.9/21.0 |
| | 100X | 26.4/20.3 |
| Elmendorf Tear (lbf) W/F | 0X | 16.6/15.1 |
| | 25X | 9.5/9.6 |
| | 100X | 9.3/8.5 |
| Taber Abrasion (Cycles) CS-10/1000 g | 0X | 1019 |
| | 25X | 882 |
| | 100X | 875 |
| Seam Slippage (lbf) | AR | none (<1/4″) |
| Stoll Flex (cycles) W/F | 0X | 4809/4991 |
| | 25X | 1430/2256 |
| | 100X | 2424/1671 |
| Aesthetic & Suitability | | |
| for Use Fabric Properties | | |
| Random Tumble Pill | | |
| Rating after 60 minutes | 0X | 3 |
| | 25X | 4 |
| | 100X | 4 |
| Xenon Arc Lightfastness: Delta E* | as received fabric | |
| | 20 hours | 4.0 |
| | 40 hours | 6.2 |
| | 60 hours | 7.6 |
| Laundry Shrinkage (%) | 1x | 2.0/0.0 |
| W/F [Industrial per NFPA 1975] | | |
| | 3x | 2.5/1.0 |
| | 5x | 3.0/1.0 |
| | 10x | 3.0/2.0 |
| | 25X | 3.7/2.2 |
| | 35x | 3.8/3.0 |
| | 40x | 4.0/3.0 |
| | 50X | 4.0/3.2 |
| | 75X | 4.0/4.0 |
| | 100x | 4.0/4.0 |
| Wash Color Fastness Delta E* | 25X | 2.6 |
| | 50X | 2.8 |
| | 75X | 4.0 |
| | 100X | 4.2 |
| Wash Color Fastness Delta L | 25X | −2.5 |
| + = getting lighter | 50X | −2.7 |
| − = getting darker | 75X | −3.9 |
| | 100X | −4.1 |
| Visual Assessment of Fabric After 25X IL | 25X | overall “good” appearance; |
| | | pilling @ 4 |
| Visual Assessment of Fabric After 50X IL | 50X | overall “average” |
| | | appearance; pilling @ 3 |
| Visual Assessment of Fabric After 75X IL | 75X | overall “average” |
| | | appearance; pilling @ 3 |
| Visual Assessment of Fabric After 100X IL | 100X | overall “average” |
| | | appearance; pilling @ 2-3 |

1. A woven protective product comprised of aramid fiber and flame retardant rayon, wherein said woven protective product exhibits an arc thermal protective value of at least 8.0 throughout the period of at least 125 cumulative wash and wear cycles.

2. A woven protective product as in claim 1, wherein the aramid fiber is present at least 50% by weight.

3. A woven protective product as in claim 1, wherein the aramid fiber is present at least 60% by weight.

4. A woven protective product as in claim 1, wherein the aramid fiber is present at least 65% by weight.

5. A personal protection article fabricated from woven protective product comprised of aramid fiber and flame retardant rayon, wherein said woven protective product exhibits an arc thermal protective value of at least 8.0 throughout the period of at least 125 cumulative wash and wear cycles.

6. A woven protective product comprised of aramid fiber and flame retardant melamine, wherein said woven protective product exhibits an arc thermal protective value of at least 8.0 throughout the period of at least 125 cumulative wash and wear cycles.

7. A woven protective product as in claim 6, wherein the aramid fiber is present at least 50% by weight.

8. A woven protective product as in claim 6, wherein the aramid fiber is present at least 60% by weight.

9. A woven protective product as in claim 6, wherein the aramid fiber is present at least 65% by weight.

10. A personal protection article fabricated from woven protective product comprised of aramid fiber and flame retardant melamine, wherein said woven protective product exhibits an arc thermal protective value of at least 8.0 throughout the period of at least 125 cumulative wash and wear cycles.
